(19) United States
(12) Patent Application Publication
(10) Pub. No.: US 2002/0182291 A1
(43) Pub. Date: Dec. 5, 2002

(54) Sweet microwave popcorn product and method for production thereof

(76) Inventors: Lis K. Renini, Anaheim Hills, CA (US); Amarjit S. Bakshi, Yorba Linda, CA (US); Caroline Ponting, Yorba Linda, CA (US)

Correspondence Address: CHRISTIE, PARKER & HALE, LLP, 350 WEST COLORADO BOULEVARD, SUITE 500, PASADENA, CA, 91105, US

(21) Appl. No.: 09/839,715

(22) Filed: Apr. 20, 2001

(51) Int. Cl. A23B 4/00

(52) U.S. Cl. 426/107

(57) ABSTRACT

A sweet microwave popcorn product is provided that can be prepared by the consumer in a single step. The product comprises a microwaveable container; a plurality of unpopped corn kernels in the container; and a plurality of sugar pellets in the container. Each sugar pellet comprises sugar in an amount of at least about 15% by weight, based on the total weight of the sugar pellet. The sugar pellets are substantially free of an emulsifying agent.

### FIELD OF THE INVENTION

The present invention relates to a sweet microwave popcorn product that can be prepared by the consumer in a single-step and a method for its production.

### BACKGROUND OF THE INVENTION

Microwaveable popcorn is one of the most popular snack foods on the market today. Currently, there are several commercially available microwaveable popcorn products containing a sugar-based glaze or coating. In these products, the sugar-based glaze or coating is added separately to the popcorn after it has been popped. Manufacturers have experienced difficulties producing a product where the sugar-based coating is formed on the popcorn during popping (i.e., in a single step) due to technical difficulties in popping popcorn and heating a sugar-based composition simultaneously in a microwave oven. Specifically, at elevated temperatures and in the presence of moisture, simple sugars darken and polymerize in a process known as carmelization. Carmelization occurs at virtually the same temperature at which popcorn pops. Carmelization is enhanced by the presence of oil in the product. As a result, when a sugar-based glaze is heated in a microwave along with the popcorn, a food product is obtained that is not only visually undesirable, but also effectively inedible due to its burnt odor and flavor. Accordingly, a need exists for a single-step sweet microwave popcorn product that avoids these drawbacks.

### SUMMARY OF THE INVENTION

The present invention concerns a sweet microwave popcorn product that can be prepared by the consumer in a single step, as well as a method for its production. In one embodiment, the invention is directed to a sweet microwave popcorn product comprising a microwaveable container; a plurality of unpopped corn kernels in the container; and a plurality of sugar pellets in the container. Each sugar pellet comprises sugar in an amount of at least about 15% by weight, based on the total weight of the sugar pellet. The sugar pellets are substantially free of an emulsifying agent.

In another embodiment, the invention is directed to a method for producing a microwave popcorn product. The method comprises providing a microwaveable container having a top, a bottom, and an opening at the top of the container. The method further comprises introducing into the container sugar pellets and unpopped corn kernels, wherein the sugar pellets and unpopped corn kernels are not homogeneously mixed; and introducing into the container an oil component, wherein more of the oil component is maintained in the container with the unpopped corn kernels than is maintained with the sugar pellets.

In another embodiment, the invention is directed to a method for producing a microwave popcorn product. The method comprises providing a microwaveable container having a top, a bottom, and an opening at the top of the container. Sugar pellets and unpopped corn kernels are introduced into the container so that the sugar pellets and unpopped corn kernels are not homogeneously mixed. Each sugar pellet comprises sugar in an amount of at least about 15% by weight, based on the total weight of the sugar pellet, and is substantially free of an emulsifying agent.

### DESCRIPTION OF THE DRAWINGS

These and other features of the advantages of the present invention will be better understood by reference to the following detailed description when considered in conjunction with the accompanying drawings wherein:

FIG. 1 is a top cut-away view of a microwave popcorn product according to the invention with the susceptor shown in phantom.

FIG. 2 is a top cut-away view of an alternative microwave popcorn product according to the invention with the susceptor shown in phantom.

### DETAILED DESCRIPTION

The invention concerns a sweet microwaveable popcorn composition comprising unpopped corn kernels, sugar pellets, and optionally an oil component. In accordance with the invention, the unpopped corn kernels can be any hulled or dehulled popcorn kernel capable of use as a microwave popcorn. The kernels may be large, medium, small, white, yellow, flavored or any other suitable type of kernel. A particularly preferred type of popcorn is “mushroom” or “butterfly” popcorn.

The sugar pellets comprise sugar and preferably corn syrup. Each sugar pellet preferably comprises at least about 15%, more preferably from about 30% to about 75%, by weight sugar, based on the total weight of the sugar pellet. As used herein, the term “sugar” includes mono-, di-, tri-, and polysaccharides, including polydextrose, as well as sugar substitutes, such as sugar alcohols, including sorbitol, xylitol, and mannitol. The preferred sugar for use in the sugar pellets of the invention is sucrose. The sugar pellets are substantially free of an emulsifying agent, and preferably contain less than 0.1 wt % of an emulsifying agent, and more preferably contain no emulsifying agent.

The corn syrup component of the sugar pellet comprises a partial hydrolysate of starch or a hydrogenated starch hydrolysate. The term “corn syrup” is further intended to embrace not only those syrups that are generally called in the trade glucose syrups, but also all other partial hydrolysates of starch including high fructose corn syrups. The term is also intended to include solid corn syrup. The sugar to corn syrup ratio in the sugar pellets preferably ranges from about 1:1 to about 5:1.

The term “pellet” as used herein is not limited to pellet-shaped or -sized pieces, but is intended to encompass all three dimensional shapes. Suitable pellet shapes include regular and irregular shapes, such as spheres, ellipses, cubes, rods, chips, flakes and the like. Suitable sugar pellets for use in connection with the invention are commercially available from Primrose Candy Company (Chicago, Ill.) and Ferrera Pan Candy Company (Forest Park, Ill.).

Regardless of the sugar used, the sugar pellets should possess a sweet taste. Therefore, if in preparing the sugar pellets, a sugar is used that does not possess a sweet taste, such as certain polysaccharides, then an additional sugar should be used that, either alone or in combination with the non-sweet sugar, possesses a sweet taste. Artificial sweeteners such as sucralose, acesulfame potassium, and aspartame can also be used to provide a sweet taste if the sugar used in preparing the pellets does not itself do so.

The sugar pellets can further comprise a polishing material, such as paraffin wax, microcrystalline wax, beeswax, candelilla wax, carnauba wax, polyethylene wax, animal fat, vegetable oil, hydrogenated vegetable oil, partially hydrogenated vegetable oil, cocoa butter, corn zein, whey protein, hydroxymethylcellulose, methylcellulose, or ethylcellulose.

To minimize burning of the sugar during microwaving, the sugar pellets have a relatively low moisture content. Preferably the moisture content of the sugar pellets ranges from about 0.5% to about 6%, more preferably from about 1% to about 5%, still more preferably from about 1.5% to about 3.5%.

A particularly preferred method for preparing the sugar pellets in accordance with the invention comprises admixing sugar and corn syrup. The admixture is heated to a temperature ranging from about 110° C. to about 170° C., more preferably from about 130C. to about 150° C., to remove moisture. The heated admixture is then formed into pellets. Preferably following heating and prior to forming pellets, the admixture is subjected to a vacuum, which helps reduce the moisture content of the pellets. The sugar pellets prepared according to this process can be, following the forming step, substantially the same size and density as the unpopped kernels.

If the sugar pellets are to comprise a polishing material, preferably following the forming step the pellets are coated with a coating material and then polished with the polishing material. Preferably the coating material (e.g., sugar syrup) is poured over the sugar pellets using traditional panning procedures as such as that described by Minifi, B. in Chocolate Manufacture, Chocolate, Cocoa and Confectionary, AVI Publishing Co., Inc., Westport, Conn. (1982), although other coating procedures known in the art may be used as well. For hot panning, the coating material is preferably a crystallizing syrup containing sucrose. Successive layers of syrup are applied to the sugar pellets with excess sugar moisture removed through the application of heat to the pan. For cold panning, the coating material is preferably a non-crystallizing syrup containing sucrose or other sugars, and one or more corn syrups. Successive layers of syrup are applied to the sugar pellets with excess syrup moisture absorbed by dry sugar or starch, which is applied directly to the syrup-coated sugar pellets. Regardless of whether a crystallizing or non-crystallizing syrup is used, the syrup can also contain minor amounts of gums, flavoring agents, and/or coloring agents. A suitable coating machine is the Thomas Engineering Accela Cota Tablet Coating System from Thomas Engineering, Inc. Other coating devices include the Driacoater, Hi-Coater, and Volvo or tulip pans. Thereafter, the pellets are coated with wax, which is then polished using a panning process, as is known in the art. Suitable waxes for use in connection with the invention include paraffin wax, microcrystalline wax, beeswax, candelilla wax, carnauba wax, and polyethylene wax.

The oil component is preferably present in the form of a slurry at elevated temperatures, e.g., around 120° C., and in generally solid form at room temperature. Oils suitable for use in the present invention include partially hydrogenated oils, such vegetable oil, sunflower oil, safflower oil, rapeseed oil, cottonseed oil, maize oil, linseed oil, high oleic acid residue containing varieties thereof, groundnut oil, and mixtures thereof. The oil enhances the flavor of the microwaved product. If desired, the oil component can include an artificial sweetener, such as those listed above. A particularly preferred composition for the oil component comprises partially hydrogenated soybean oil, salt, color, butter flavor and sucralose.

The oil component can further include a flavoring agent and/or coloring agent. Suitable flavoring agents include natural and artificial flavors, such as synthetic flavor oils and flavoring aromatics and/or oils, oleoresins and extracts derived from plants, leaves, flowers, fruits, and so forth, and combinations thereof. Particularly useful flavorings include artificial, natural and synthetic fruit flavors such as vanilla, and citrus oils including lemon, orange, lime, grapefruit, and fruit essences including apple, pear, peach, grape, strawberry, raspberry, cherry, plum, pineapple, and apricot. The flavoring agents may be in liquid or solid form. Commonly used flavors include mints such as peppermint, menthol, artificial vanilla, cinnamon derivatives, and various fruit favors. Other flavorings that can be used include aldehyde flavorings, such as acetaldehyde (apple), benzaldehyde (cherry, almond), anisic aldehyde (licorice, anise), cinnamic aldehyde (cinnamon), citral, i.e., alpha-citral (lemon, lime), neral, i.e., beta-citral (lemon, lime), decanal (orange, lemon), ethyl vanillin (vanilla, cream), heliotrope, i.e., piperonal (vanilla, cream), vanillin (vanilla, cream), alpha-amyl cinnamaldehyde (spicy fruity flavors), butyraldehyde (butter, cheese), valeraldehyde (butter, cheese), citronellal (modifies, many types), decanal (citrus fruits), aldehyde C-8 (citrus fruits), aldehyde C-9 (citrus fruits), aldehyde C-12 (citrus fruits), 2-ethylbutyeraldehyde (berry fruits), hexenel, i.e., trans-2 (berry fruits), tolyl aldehyde (cherry, almond), veratraldehyde (vanilla), 2,6-dimethyl-5-heptanal, i.e., melonal (melon), 2,6-dimethyloctanal (green fruit), and 2-dodecenal (citrus, mandarin), cherry, grape, strawberry shortcake, and the like. Preferred flavoring agents include butter, brown sugar, caramel, cooked milk, maple, vanilla, cream, pastry, marshmallow, cheese, cinnamon, and honey. Other examples of suitable flavoring agents are described in S. Arctander, Perfume and Flavor Chemicals (1969) and Allure Publishing Corporation's Flavor and Fragrance Materials (1993), the disclosures of which are incorporated herein by reference. In general, the amount of flavoring agent used should be in an amount effective to provide the desired or acceptable taste to the consumer.

Coloring agents may be included in an amount up to about 10% by weight, preferably no more than about 6% by weight, of the microwaveable popcorn composition. Suitable coloring agents include natural food colors and dyes suitable for food, drug and cosmetic applications, which are preferably oil-dispersible, including the indigoid dye known as F.D. & C. Blue No. 2, the disodiurn salt of 5,5-indigotindisulfonic acid), and the dye known as F.D. & C. Green No. 1, the monosodium salt of 4-[4-(N-ethyl-p-sulfoniumbenzylamino) diphenylmethylene]-[1-(N-ethyl-N-P -sulfoniumbenzyl)-delta-2,5-cyclohexadieneimine.

The oil component preferably also includes salt. Any suitable type of salt can be used, including coarse, fine or extra fine salt. The salt is preferably present in an amount up to about 10%, more preferably from about 0.5% to about 6% by weight, based on the total weight of the composition. However, because the salt increases the burning of the sugar, the precise amount of salt used will depend on the presence, size and shape of the susceptor used in the packaging, discussed further below.

If desired, the salt, flavoring agent and/or coloring agent can be combined with the sugar pellet in addition to or instead of with the oil component. Salt can alternatively be sprinkled or otherwise provided in the bag with the unpopped corn kernels.

The composition is provided in a microwaveable package, for which any conventional popcorn bag or tub arrangement may be used. A suitable popcorn bag for use in connection with the invention comprises a conventional 2-ply bag arrangement with a pinch-bottom design. Such an arrangement is generally described in U.S. Pat. No. 5,044,777, the disclosure of which is incorporated herein by reference. Generally, the bag is folded from a 2-ply panel or sheet to form a bag having a length ranging from about 10 to about 14 inches, preferably from about 11 to about 12 inches, and a width ranging from about 4.5 to about 7 inches, preferably from about 5 to 6.5 inches. The sheet of paper that forms the outer surface of the bag, when folded, is preferably a 23-30 lb blended Kraft paper (lb/ream). The sheet of paper that forms the inside of the bag is preferably a 23-25 lb. greaseproof paper. Both papers may be treated with a fluorochemical material for grease resistance, such as 3M fluorocarbon FC807. The laminating adhesive between the plies of paper could be a typical conventional adhesive used in such arrangements, for example Duracet 12, available from Franklin International, Inc. of Columbus, Ohio, or H. B. Fuller WO-3460ZZ, available from H. B. Fuller, St. Paul, Minn. The folded bag has a top surface and a bottom surface. When the bag is placed in a microwave oven, as described further below, the bottom surface of the bag rests on the inner surface of the microwave oven, as is generally known in the art.

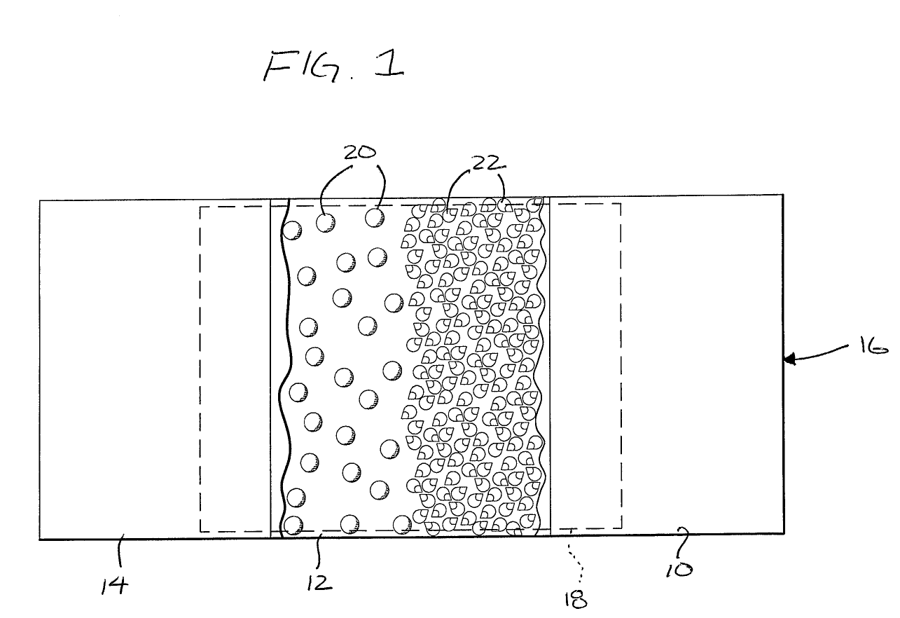

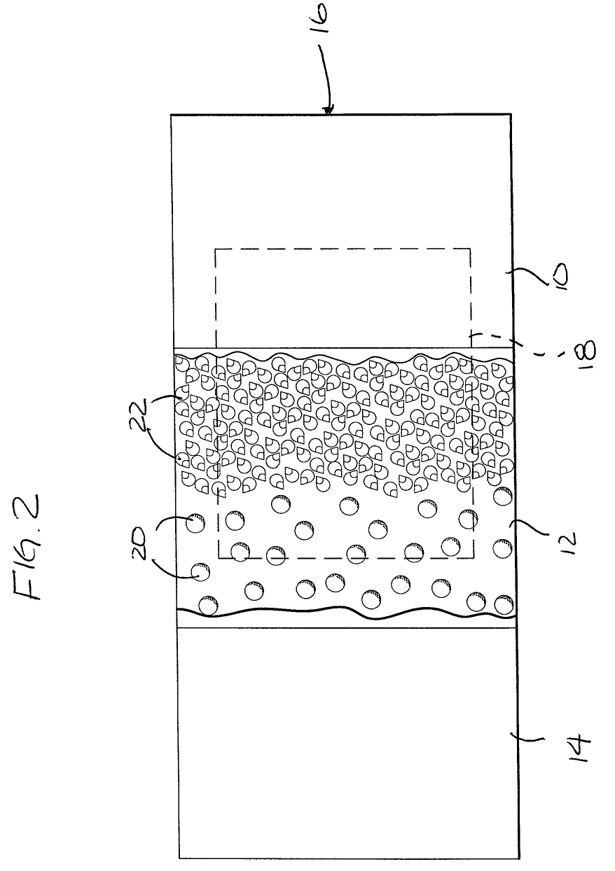

In a preferred embodiment, the folded bag is folded into three approximately evenly sized regions, as shown in FIGS. 1 and 2, namely, a top region 10, a middle region 12, and a bottom region 14, with the top region 10 nearest the bag opening 16. However, when the product is exposed to microwave energy, thereby expanding the bag, the resulting volume in each of the top and bottom regions is less than the volume of the middle region.

Preferably the microwave package includes a susceptor for enhancing the popping of the kernels. Once placed under microwave energy, the packaging containing the susceptor reaches temperatures in excess of 300° F. almost instantaneously.

In a preferred embodiment, the microwave susceptor is positioned between the two plies of the bag described above on the bag's bottom surface. The susceptor is preferably provided in a location over which the unpopped corn kernels rest when the bag arrangement is unfolded and placed in a microwave oven for cooking, as described in more detail below. The susceptor can comprise any of a variety of microwave interactive materials, such as a thin layer of metal, e.g., vapor deposited metal, metal oxide, carbon and the like. The susceptor can be applied directly to the interior of the bag, preferably between the two plies, or can be supported on a sheet of paper or plastic that is subsequently bonded to the packaging. The susceptor preferably comprises a metallized polymeric film, such as Hoechst Celanise polyester film (typically 48-92 gauge) vacuum metallized with aluminum to give a density of 0.2-0.3 (as measured by a Tobias densitometer). In the embodiment depicted in FIG. 1, the susceptor 18 is provided in primary part in the middle region 12 of the folded bag nearest the unpopped kernels, as described further below.

To make the microwave product of the invention, the components are introduced into the microwaveable package. Preferably the sugar pellets are introduced into the package separately from the oil component, if included, to minimize burning of the sugar pellets. In a particularly preferred method, the bag is provided in a generally upright position, i.e., with the opening 16 at the top of the bag, as the components are introduced into the bag. However, before the components are introduced into the bag, the bottom region 14 of the bag is folded under so that the components cannot enter the bottom region, but instead remain in the middle region 12. In one method according to the invention, the sugar pellets are introduced first. Thereafter, the unpopped kernels are introduced into the bag, with the oil component introduced over the kernels. The oil component, particularly when in the form of a slurry, generally remains with the unpopped kernels. With this arrangement, the corn acts generally as a buffer between the sugar pellets and the oil component, thereby reducing burning of the sugar pellets.

In an alternative method, the sugar pellets are deposited into a cup, and thereafter the unpopped kernels are introduced into the cup on top of the sugar pellets. The contents of the cup are then released into the microwaveable bag so that the sugar pellets and unpopped kernels are generally arranged as described above. Thereafter, the oil component is introduced directly into the microwaveable bag so that it mixes generally with the unpopped kernels, similar to the method described above.

The precise order that the components are introduced into the microwaveable package is not critical to invention, but can be selected to reduce burning of the sugar to the extent that the sugar pellets are maintained as separate from the oil component as possible. Thus, it is preferred that the majority of the sugar pellets 20 is contained with a portion of the middle region 12 nearest the bottom region 14 or the top region 12, and the majority of the unpopped corn kernels 22 and the majority of the oil component are contained within a portion of the middle region nearest the other of the bottom region or the top region, as shown in FIG. 1.

After the components are introduced, the bag is sealed closed, and the bag is folded up so that the top region 10 and the bottom region 14 overlay the middle region 12, as is generally known in the art. Preferably after the microwave bag is filled with the inventive composition and folded, it is covered with a cellophane overwrap, such as 140-160 gauge biaxially oriented polypropylene, or the like. Heavier gauges (or wraps with improved moisture barrier characteristics) are preferred for improved moisture retention.

The amounts of the components in the composition will vary depending on the presence, size and shape of the susceptor. Generally, the composition preferably comprises the unpopped kernels in an amount ranging from about 15% to about 95% by weight, based on the weight of the composition. The sugar pellets are preferably present in an amount ranging from about 1% to about 70% by weight, based on the weight of the composition. The oil component, when included, is preferably present in an amount up to about 50% by weight, based on the weight of the composition. If a susceptor is included in the bag, preferably the relative amount of sugar pellets is reduced because the susceptor, while enhancing the popping of the kernels, also increases the likelihood that the sugar will burn.

When the bag does not contain a susceptor, the amount of sugar pellets preferably ranges from about 10% to about 70%, more preferably from about 20% to about 70%, by weight based on the total weight of the composition.

FIG. 1 depicts a bag having a full susceptor, i.e., a susceptor 18 covering substantially all of the middle region 12. In this embodiment, the susceptor has a width equal to at least about 90% of the width of the bag, preferably at least about 95% of the width of the bag. The susceptor has a length equal to at least about 40% of the length of the bag, more preferably at least about 50% of the length of the bag. In the depicted embodiment, the susceptor covers the entire length of the middle region and extends approximately equal lengths into the top and bottom regions. In such an embodiment, the amount of unpopped corn preferably ranges from about 40% to about 95%, more preferably from about 45% to about 75%, the amount of sugar pellets preferably ranges from about 1% to about 10%, more preferably from about 2% to about 4%, and the amount of oil component preferably ranges from about 10% to about 45%, more preferably from about 20% to about 40%, wherein the percentages are by weight, based on the total weight of the components in the bag. When the sugar pellets 20 are introduced first, they are located in the middle region 12 nearest the bottom region 14; the unpopped corn kernels 22, along with the oil component, are located in the middle region nearest the top region 10. As shown in FIG. 1, the sugar pellets 20 are generally separate from the unpopped corn kernels 22 and oil component, although some mixing of these components naturally occurs upon their introduction into the bag. However, it is preferred that the sugar pellets are not homogeneously mixed with the unpopped corn kernels, and even more preferred that the sugar pellets are not homogeneously mixed with the oil component.

FIG. 2 depicts a bag identical to the bag of FIG. 1 in all respects except that it has a partial (or short) susceptor, which covers only a portion of the middle region 12. In this embodiment, the susceptor preferably has a width ranging from about 60% to about 90% of the width of the bag, more preferably ranging from about 75% to about 85% of the width of the bag. The susceptor has a length preferably ranging from about 25% to about 50%, more preferably from about 30% to about 40%, of the length of the bag. In the depicted embodiment, the susceptor covers approximately 80% of the length of the middle region, does not cover the portion of the middle region nearest the bottom region, and extends into the top region. In this embodiment, the amount of unpopped corn kernels preferably ranges from about 20% to about 80%, more preferably from about 25% to about 55%, the amount of sugar pellets preferably ranges from about 5% to about 35%, more preferably from about 15% to about 25%, and the amount of oil component preferably ranges from about 20% to about 50%, more preferably from about 30% to about 50%, wherein the percentages are by weight based on the total weight of the components in the bag. It is preferred that the susceptor covers less than 90% of the length of the middle region, thereby creating a portion of the middle region not covered by the susceptor that corresponds to the portion of the middle region in which the majority of the sugar pellets is contained. It is further preferred that the majority of the sugar pellets 20 is provided in the portion of the middle region nearest the bottom region, and the majority of the corn kernels 22 and the majority of the oil component, if included, are provided in the portion of the middle region nearest the top region, with the susceptor not covering at least some of portion of the middle region in which the sugar pellets are contained.

The microwave popcorn products of the invention can be quickly and conveniently prepared by the consumer in a single step. The consumer removes any cellophane overwrap from the microwaveable bag, and places the bag in the microwave oven with the bottom surface of the bag resting on the inner surface of the microwave oven. In the case of a tri-fold bag as described above, typically initially only the bottom surface of the middle region is resting on the surface of the microwave oven. As the product is exposed to microwave energy, the bag expands, as is well known in the art. Suitable microwaving times for the products of the invention range from about 1.5 minutes to about 4 minutes, and can vary based on a number of variables, including the power of the microwave being used and the presence and size of the susceptor in the microwaveable container.

Four microwave popcorn products were prepared, with compositions and susceptor designs as shown in Table 1. In each example, the bag was a two-ply bag with a pinched bottom and single-gusset sides. The bag had a length of approximately 11.5 inches, a width of approximately 5.75 inches, and was folded to form three substantially equally-sized regions, as generally described above. The bottom region of the bag was folded so that, as the components were introduced into the top of the bag, they remained in the middle region. The bags of Examples 1 and 2 did not include a susceptor. The bag of Example 3 contained a full susceptor, i.e., a susceptor having a width of approximately 5.5 inches and a length of approximately 6.25 inches, with the susceptor covering almost all of the middle region and a portion of the top and bottom regions, as shown in FIG. 1. The bag of Example 4 contained a short susceptor, i.e., a susceptor having a width of approximately 4.25 inches and a length of approximately 4.5 inches, with the susceptor covering approximately 80% of the length of the middle region and a portion of the top region. All of the microwave popcorn products were tasty and exhibited minimal sugar burning during popping of the kernels.

TABLE 1

| | Example 1 | Example 2 | Example 3 | Example 4 |
|---|---|---|---|---|
| Susceptor | None | None | Full | Short |
| Corn Kernels | 75 grams | 20 grams | 67 grams | 35 grams |
| Sugar Pellets | 25 grams | 60 grams | 2 grams | 20 grams |
| Oil Component | None | 40 grams | 31 grams | 45 grams |

The preceding description has been presented with reference to presently preferred embodiments of the invention. Workers skilled in the art and technology to which this invention pertains will appreciate that alterations and changes in the described structure may be practiced without meaningfully departing from the principal, spirit and scope of this invention. Accordingly, the foregoing description should not be read as pertaining only to the precise structures described and illustrated in the accompanying drawings, but rather should be read consistent with and as support to the following claims which are to have their fullest and fair scope.

1. A sweet microwave popcorn product comprising:
a microwaveable container;
a plurality of unpopped corn kernels in the container; and
a plurality of sugar pellets in the container, wherein each sugar pellet comprises sugar in an amount of at least about 15% by weight, based on the total weight of the sugar pellet, wherein the sugar pellets are substantially free of an emulsifying agent.

2. A microwave popcorn product according to claim 1, wherein the sugar pellets are not homogeneously mixed with the unpopped kernels.

3. A microwave popcorn product according to claim 1, wherein the sugar pellets do not contain an emulsifying agent.

4. A microwave popcorn product according to claim 1, wherein the sugar pellets further comprise corn syrup.

5. A microwave popcorn product according to claim 4, wherein the ratio of sugar to corn syrup in each sugar pellet ranges from about 1:1 to about 5:1.

6. A microwave popcorn product according to claim 1, wherein the unpopped corn kernels are present in a total amount ranging from about 15% to about 95% by weight based on the total weight of the product excluding the container.

7. A microwave popcorn product according to claim 1, wherein the sugar pellets are present in a total amount ranging from about 1% to about 70% by weight based on the total weight of the product excluding the container.

8. A microwave popcorn product according to claim 1, wherein each sugar pellet has a moisture content no greater than about 3.5%.

9. A microwave popcorn product according to claim 1, wherein each sugar pellet has a moisture content no greater than about 2.5%.

10. A microwave popcorn product according to claim 1, wherein the sugar pellets are prepared according to the process comprising:
admixing sugar and corn syrup to produce an admixture;
reducing the moisture content of the admixture by heating the admixture to a temperature ranging from about 110° C. to about 170° C.; and
forming the heated admixture into pellets.

11. A microwave popcorn product according to claim 10, wherein the process further comprises subjecting the heated admixture to a vacuum to further reduce the moisture content of the admixture.

12. A microwave popcorn product according to claim 1, wherein the product further comprises an oil component in the container, wherein the oil component is not homogeneously mixed with the sugar pellets.

13. A microwave popcorn product according to claim 12, wherein the oil component comprises partially hydrogenated soybean oil, salt, color, butter flavor and sucralose.

14. A microwave popcorn product according to claim 1, wherein the produce further comprises salt in the container.

15. A microwave popcorn product according to claim 14, wherein the salt is present in a total amount up to about 10% by weight based on the total weight of the product excluding the container.

16. A microwave popcorn product according to claim 1, wherein the microwaveable container does not include a susceptor.

17. A microwave popcorn product according to claim 16, wherein the sugar pellets are present in a total amount ranging from about 10% to about 70% by weight based on the total weight of the product excluding the container.

18. A microwave popcorn product according to claim 1, wherein the microwaveable container includes a susceptor.

19. A microwave popcorn product according to claim 18, wherein the microwaveable container comprises a bag having a top surface and a bottom surface, and further wherein the susceptor is generally flat and attached to the bottom surface of the bag.

20. A microwave popcorn product according to claim 19, wherein the susceptor extends over at least about 40% of the length of the bag.

21. A microwave popcorn product according to claim 19, wherein the susceptor extends over at least about 50% of the length of the bag.

22. A microwave popcorn product according to claim 21, wherein the unpopped corn kernels are present in a total amount ranging from about 40% to about 95% by weight based on the total weight of the product excluding the container.

23. A microwave popcorn product according to claim 21, wherein the unpopped corn kernels are present in a total amount ranging from about 45% to about 75% by weight based on the total weight of the product excluding the container.

24. A microwave popcorn product according to claim 21, wherein the sugar pellets are present in a total amount ranging from about 1% to about 10% by weight based on the total weight of the product excluding the container.

25. A microwave popcorn product according to claim 21, wherein the sugar pellets are present in a total amount ranging from about 2% to about 4% by weight based on the total weight of the product excluding the container.

26. A microwave popcorn product according to claim 21, wherein the product further comprises an oil component present in a total amount ranging from about 10% to about 45% by weight based on the total weight of the product excluding the container.

27. A microwave popcorn product according to claim 21, wherein the product further comprises an oil component present in a total amount ranging from about 20% to about 40% by weight based on the total weight of the product excluding the container.

28. A microwave popcorn product according to claim 21, wherein:
the unpopped corn kernels are present in a total amount ranging from about 40% to about 95% by weight based on the total weight of the product excluding the container;
the sugar pellets are present in a total amount ranging from about 1% to about 10% by weight based on the total weight of the product excluding the container; and
the product further comprises an oil component present in a total amount ranging from about 10% to about 45% by weight based on the total weight of the product excluding the container.

29. A microwave popcorn product according to claim 21, wherein:
the unpopped corn kernels are present in a total amount ranging from about 45% to about 75% by weight based on the total weight of the product excluding the container;
the sugar pellets are present in a total amount ranging from about 2% to about 4% by weight based on the total weight of the product excluding the container; and
the product further comprises an oil component present in a total amount ranging from about 20% to about 40% by weight based on the total weight of the product excluding the container.

30. A microwave popcorn product according to claim 29, wherein the susceptor covers at least about 90% of the width of the bag.

31. A microwave popcorn product according to claim 19, wherein the susceptor covers from about 25% to about 50% of the length of the bag.

32. A microwave popcorn product according to claim 19, wherein the susceptor covers from about 30% to about 40% of the length of the bag.

33. A microwave popcorn product according to claim 31, wherein the susceptor covers from about 75% to about 85% of the width of the bag.

34. A microwave popcorn product according to claim 31, wherein the unpopped corn kernels are present in a total amount ranging from about 20% to about 80% by weight based on the total weight of the product excluding the container.

35. A microwave popcorn product according to claim 31, wherein the unpopped corn kernels are present in a total amount ranging from about 25% to about 55% by weight based on the total weight of the product excluding the container.

36. A microwave popcorn product according to claim 31, wherein the sugar pellets are present in a total amount ranging from about 5% to about 35% by weight based on the total weight of the product excluding the container.

37. A microwave popcorn product according to claim 31, wherein the sugar pellets are present in a total amount ranging from about 15% to about 25% by weight based on the total weight of the product excluding the container.

38. A microwave popcorn product according to claim 31, wherein the product further comprises an oil component present in a total amount ranging from about 20% to about 50% by weight based on the total weight of the product excluding the container.

39. A microwave popcorn product according to claim 31, wherein the product further comprises an oil component present in a total amount ranging from about 30% to about 50% by weight based on the total weight of the product excluding the container.

40. A microwave popcorn product according to claim 31, wherein:
the unpopped corn kernels are present in a total amount ranging from about 25% to about 55% by weight based on the total weight of the product excluding the container;
the sugar pellets are present in a total amount ranging from about 15% to about 25% by weight based on the total weight of the product excluding the container; and
the product further comprises an oil component present in a total amount ranging from about 30% to about 50% by weight based on the total weight of the product excluding the container.

41. A microwave popcorn product according to claim 19, wherein the bag has a bottom region, a middle region adjacent the bottom region, a top region adjacent the middle region, and an opening in contact with the top region, wherein the bottom region, middle region and top region are approximately equal in length; and further wherein the bag is folded so that the bottom region and top region overlay the middle region.

42. A microwave popcorn product according to claim 41, wherein the unpopped corn kernels and sugar pellets, along with an oil component are contained substantially within the middle region.

43. A microwave popcorn product according to claim 42, wherein the majority of the sugar pellets is contained with a portion of the middle region nearest the bottom region or the top region, and further wherein the majority of the unpopped corn kernels and the majority of the oil component are contained within a portion of the middle region nearest the other of the bottom region or the top region.

44. A microwave popcorn product according to claim 43, wherein the susceptor covers substantially the entire length of the middle region.

45. A microwave popcorn product according to claim 44, wherein:
the unpopped corn kernels are present in a total amount ranging from about 40% to about 95% by weight based on the total weight of the product excluding the container;
the sugar pellets are present in a total amount ranging from about 1% to about 10% by weight based on the total weight of the product excluding the container; and
the oil component is present in a total amount ranging from about 10% to about 45% by weight based on the total weight of the product excluding the container.

46. A microwave popcorn product according to claim 44, wherein:
the unpopped corn kernels are present in a total amount ranging from about 45% to about 75% by weight based on the total weight of the product excluding the container;
the sugar pellets are present in a total amount ranging from about 2% to about 4% by weight based on the total weight of the product excluding the container; and
the product further comprises an oil component present in a total amount ranging from about 20% to about 40% by weight based on the total weight of the product excluding the container.

47. A microwave popcorn product according to claim 43, wherein the susceptor covers less than 90% of the length of the middle region, thereby creating a portion of the middle region not covered by the susceptor that corresponds to the portion of the middle region in which the majority of the sugar pellets is contained.

48. A microwave popcorn product according to claim 47, wherein:
the unpopped corn kernels are present in a total amount ranging from about 25% to about 55% by weight based on the total weight of the product excluding the container;
the sugar pellets are present in a total amount ranging from about 15% to about 25% by weight based on the total weight of the product excluding the container; and
the oil component is present in a total amount ranging from about 30% to about 50% by weight based on the total weight of the product excluding the container.

49. A microwave popcorn product according to claim 1, wherein each sugar pellet comprises sugar in an amount ranging from about 30% to about 75% by weight, based on the weight of the sugar pellet.

50. A microwave popcorn product according to claim 1, wherein the sugar pellets each further comprise a polishing material.

51. A method for producing a microwave popcorn product comprising:
providing a microwaveable container having a top, a bottom, and an opening at the top of the container;
introducing into the container sugar pellets and unpopped corn kernels, wherein the sugar pellets and unpopped corn kernels are not homogeneously mixed;
introducing into the container an oil component, wherein more of the oil component is maintained in the container with the unpopped corn kernels than is maintained with the sugar pellets.

52. A method according to claim 51, wherein the sugar pellets are introduced into the container before the unpopped kernels are introduced into the container.

53. A method according to 51, wherein the sugar pellets are introduced into the container before the oil component is introduced into the container.

54. A method according to 51, wherein the container includes a susceptor over at least a portion of the length of the container.

55. A method according to 51, wherein the microwaveable container comprises a bag having a top surface, a bottom surface, and a generally-flat susceptor attached to the bottom surface of the bag.

56. A method according to claim 55, wherein the susceptor extends over at least about 50% of the length of the bag.

57. A method according to claim 56, wherein
the unpopped corn kernels are introduced in a total amount ranging from about 40% to about 95% by weight based on the total weight of the product excluding the container;
the sugar pellets are introduced in a total amount ranging from about 1% to about 10% by weight based on the total weight of the product excluding the container; and
the oil component is introduced in a total amount ranging from about 10% to about 45% by weight based on the total weight of the product excluding the container.

58. A method according to claim 55, wherein the susceptor covers at least about 90% of the width of the bag.

59. A method according to claim 58, wherein:
the unpopped corn kernels are introduced in a total amount ranging from about 25% to about 55% by weight based on the total weight of the product excluding the container;
the sugar pellets are introduced in a total amount ranging from about 15% to about 25% by weight based on the total weight of the product excluding the container; and
the oil component is introduced in a total amount ranging from about 30% to about 50% by weight based on the total weight of the product excluding the container.

60. A method according to claim 54, wherein the bag has a bottom region, a middle region adjacent the bottom region, a top region adjacent the middle region, and an opening in contact with the top region, wherein the bottom region, middle region and top region are approximately equal in length; and further wherein the bag is folded so that the bottom region and top region overlay the middle region.

61. A method according to claim 60, wherein the unpopped corn kernels, sugar pellets, and oil component are contained substantially within the middle region.

62. A method according to claim 61, wherein the majority of the sugar pellets is contained with a portion of the middle region nearest the bottom region or the top region, and further wherein the majority of the unpopped corn kernels and the majority of the oil component are contained within a portion of the middle region nearest the other of the bottom region or the top region.

63. A method according to claim 62, wherein the susceptor covers substantially the entire length of the middle region.

64. A method according to claim 63, wherein:
the unpopped corn kernels are introduced in a total amount ranging from about 40% to about 95% by weight based on the total weight of the product excluding the container;
the sugar pellets are introduced in a total amount ranging from about 1% to about 10% by weight based on the total weight of the product excluding the container; and
the oil component is introduced in a total amount ranging from about 10% to about 45% by weight based on the total weight of the product excluding the container.

65. A method according to claim 63, wherein:
the unpopped corn kernels are introduced in a total amount ranging from about 45% to about 75% by weight based on the total weight of the product excluding the container;
the sugar pellets are introduced in a total amount ranging from about 2% to about 4% by weight based on the total weight of the product excluding the container; and
the oil component is introduced in a total amount ranging from about 20% to about 40% by weight based on the total weight of the product excluding the container.

66. A method according to claim 62, wherein the susceptor covers less than 90% of the length of the middle region, thereby creating a portion of the middle region not covered by the susceptor that corresponds to the portion of the middle region in which the majority of the sugar pellets is contained.

67. A method according to claim 66, wherein:
the unpopped corn kernels are introduced in a total amount ranging from about 25% to about 55% by weight based on the total weight of the product excluding the container;
the sugar pellets are introduced in a total amount ranging from about 15% to about 25% by weight based on the total weight of the product excluding the container; and
the oil component is introduced in a total amount ranging from about 30% to about 50% by weight based on the total weight of the product excluding the container.

68. A method for producing a microwave popcorn product comprising:
providing a microwaveable container having a top, a bottom, and an opening at the top of the container; and
introducing into the container sugar pellets and unpopped corn kernels so that the sugar pellets and unpopped corn kernels are not homogeneously mixed, wherein each sugar pellet comprises sugar in an amount of at least about 15% by weight, based on the total weight of the sugar pellet, and is substantially free of an emulsifying agent.
